(19) United States
(12) Patent Application Publication
(10) Pub. No.: US 2007/0280238 A1
(43) Pub. Date: Dec. 6, 2007

(54) Method and system for passive loop detection and prevention in a packet network switch

(76) Inventor: Martin Lund, Palo Alto, CA (US)

Correspondence Address: MCANDREWS HELD & MALLOY, LTD, 500 WEST MADISON STREET, SUITE 3400, CHICAGO, IL, 60661, US

(21) Appl. No.: 11/442,745

(22) Filed: May 30, 2006

(51) Int. Cl. H04L 12/56

(52) U.S. Cl. 370/392; 370/401

(57) ABSTRACT

Certain aspects of a method and system for passive loop detection and prevention in a packet network switch are disclosed. Aspects of one method may include detecting a loop within a switch in a communication network based on a number of occurrences of at least a portion of a plurality of received network packets at a port in the switching device. The rate at which at least a portion of the plurality of received network packets are handled may be adjusted at the port in the switching device. At least one of the plurality of received network packets at the port may be rate limited or at least one of a plurality of ports in the switching device handling the plurality of received network packets may be disabled, if the number of occurrences of a CRC hash value of at least one of the plurality of received network packets is above a first threshold value.

### CROSS-REFERENCE TO RELATED APPLICATIONS/INCORPORATION BY REFERENCE

This application makes reference to:
U.S. application Ser. No. ______ (Attorney Docket No. 17079US01) filed on even date herewith;
U.S. application Ser. No. ______ (Attorney Docket No. 17080US01) filed on even date herewith;
U.S. application Ser. No. ______ (Attorney Docket No. 17081US01) filed on even date herewith; and
U.S. application Ser. No. ______ (Attorney Docket No. 17082US01) filed on even date herewith.

Each of the above stated applications is hereby incorporated herein by reference in its entirety.

### FIELD OF THE INVENTION

Certain embodiments of the invention relate to network switches. More specifically, certain embodiments of the invention relate to a method and system for passive loop detection and prevention in a packet network switch.

### BACKGROUND OF THE INVENTION

In a telecommunications network, a switch is a device that channels incoming data from any of a plurality of input ports to at least one output port that will communicate the data toward its intended destination. In the traditional circuit-switched telephone network, one or more switches are used to set up a dedicated temporary connection or circuit for an exchange between two or more parties. On an Ethernet local area network (LAN), a switch determines which output port to forward a particular packet frame based on the medium access control (MAC) address of the received packet frame. In a packet switched IP network, a switch may determine which output port to use to route the network packet based on the IP address of each packet.

Various software algorithms and applications have been developed to discover the topology of a network and detect the presence of loops in a network. Whenever a loop is detected, the traffic on those ports that form the loop may be blocked. A blocked port may not be used to forward traffic since it would result in the forwarded traffic being looped back and subsequently received at the output port from which it was communicated. Standardized protocols such as spanning tree and rapid spanning tree are utilized to detect and prevent occurrences of loops within a network. Such methods for detecting and preventing loops may be referred to as active methods.

A loop generally creates a high concentration of traffic, which excludes other applications from communicating data over the input and output ports that form the loop. If a sufficient amount of switch ports are placed in a loop, this may render the switch inoperable. This may occur in instances where traffic in a loop is also being broadcasted to other ports and may reduce those portions of a network that is served solely by the switch.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for passive loop detection and prevention in a packet network switch, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary loop in a network that may be utilized in connection with an embodiment of the invention.

FIG. 1B is a block diagram illustrating a host with a separate network interface hardware (NIHW) block, in accordance with an embodiment of the invention.

FIG. 1C is a block diagram illustrating a host with a network interface hardware block integrated within a chipset, in accordance with an embodiment of the invention.

FIG. 2 is a diagram that illustrates a system for passive loop detection and prevention, in accordance with an embodiment of the invention.

FIG. 3A is a diagram that illustrates an exemplary management function, in accordance with an embodiment of the invention.

FIG. 3B is a diagram that illustrates an exemplary scenario of a management function in which the default threshold has been exceeded, in accordance with an embodiment of the invention.

FIG. 3C is a diagram that illustrates an exemplary scenario of a management function with an adaptive threshold, in accordance with an embodiment of the invention.

FIG. 4 is a flowchart illustrating a method for passive loop detection and prevention, in accordance with an embodiment of the invention.

### DETAILED DESCRIPTION OF THE INVENTION

Certain embodiments of the invention may be found in a method and system for passive loop detection and prevention in a packet network switch. Certain aspects of the invention may provide a method and system for detecting a loop within a switch in a communication network based on a number of occurrences of at least a portion of a plurality of received network packets at a port in the switching device. The rate at which at least a portion of the plurality of received network packets are handled may be adjusted at the port in the switching device. At least one of the plurality of received network packets at the port may be rate limited or at least one of a plurality of ports in the switching device handling the plurality of received network packets may be disabled, if the number of occurrences of a CRC hash value of at least one of the plurality of received network packets is above a first threshold value.

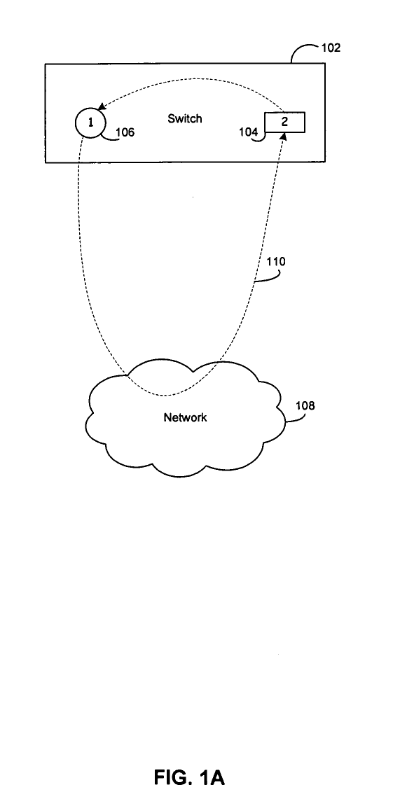

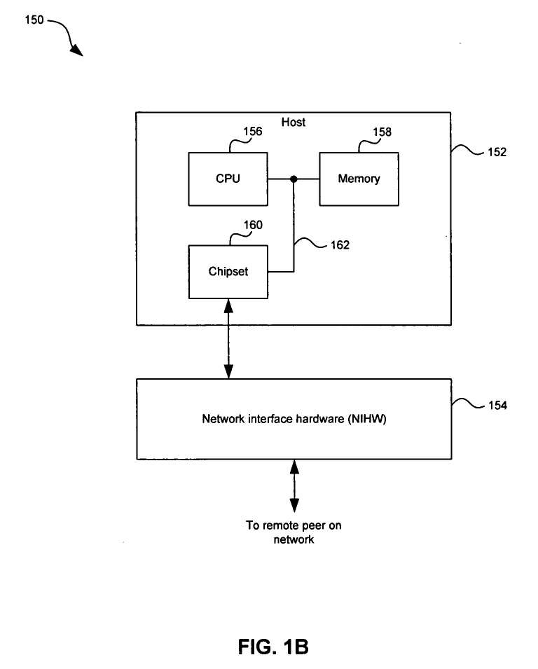

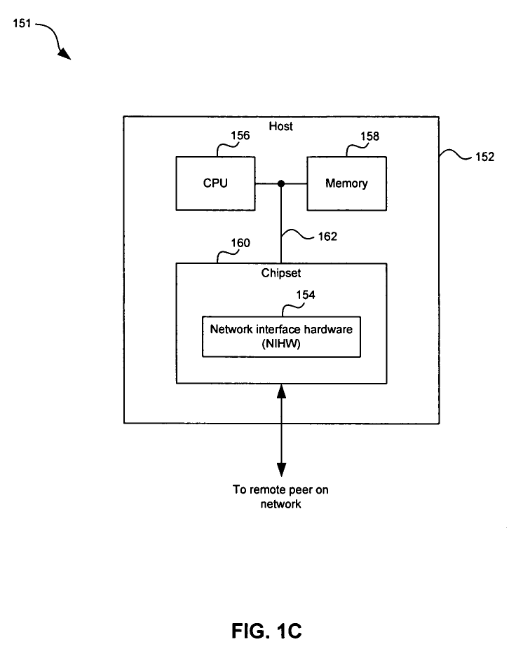

FIG. 1A is a diagram illustrating an exemplary loop in a network that may be utilized in connection with an embodiment of the invention. Referring to FIG. 1A, there is shown a packet network switch 102, a network 108 and a network loop data path 110. The packet network switch 102 may comprise an input port 2 104 and an output port 1 106.

The loop 110 illustrates data being communicated from the output port 1 106 of the packet network switch 102 through the network 108 and being received at an input port 2 104 of the packet network switch 102. The same data that is received at the input port 2 104 may be then communicated back to the output port 1 106, thereby creating a loop. A loop 110 may occur when data is transmitted from the first output switch port 106, received at a first input port 104 of the same switch 102 and is communicated back to the first output switch port 106.

In accordance with various embodiments of the invention, a passive methodology may be utilized to detect and handle loops that may occur in a network 108. This may be utilized in instances where the spanning tree or rapid spanning tree algorithm is not running. Each frame handled by the switch 102 may be tracked by a classifier that examines each frame to determine its identity. For example, a hashing operation may be performed across each received frame and the corresponding hash information related to each frame may be stored, for example, in a table in memory. The hash information may be examined to determine whether there are multiple occurrences of the same received frame. The accuracy of the hashing algorithm may adequately detect multiple frame occurrences. If examination of the hashed information indicates that a frame is to be communicated through the switch 102 at a rate that may exceed a threshold or other determined rate, then this may indicate the presence of a loop in the network 108. In most networks, this may be a fair assumption since there would be no value in sending the same information through the switch constantly, except for testing purposes.

In another embodiment of the invention, every packet that traverses the switch 102 may be monitored and compared with the previously monitored data packets. In another embodiment of the invention, the passive loop detection may be utilized for denial of attack prevention and flow monitoring.

FIG. 1B is a block diagram illustrating a host with a separate network interface hardware (NIHW) block, in accordance with an embodiment of the invention. Referring to FIG. 1B, there is shown a networking system 150, such as a server, a client, or a similar network machine, for example, that may comprise a host 152 and a network interface hardware (NIHW) device 154. The host 152 may comprise a central processing unit (CPU) 156, a memory 158, and a chipset 160. The CPU 156, the memory 158, and the chipset 160 may be communicatively coupled via, for example, a bus 162.

The networking system 150 may enable operation or support of various networking protocols. For example, the networking system 150 may enable supporting of transport control protocol/Internet protocol (TCP/IP) connections. In this regard, the networking system 150 may enable supporting of Internet control message protocol (ICMP), address resolution protocol (ARP), stream control transmission protocol (SCTP), and/or path maximum transmission unit (PMTU) discovery protocol, for example. The ICMP protocol may refer to an ISO/OSI layer 3 protocol that may allow routers, for example, to send error and/or control messages about packet processing on IP networks. The ARP protocol may refer to a low-level protocol within the TCP/IP suite that may map IP addresses to corresponding Ethernet addresses. The SCTP may support the transport of public switched telephone networks (PSTN) signaling messages over connectionless packet networks such as IP networks, for example. The PMTU may refer to a maximum unit of data that may be sent given a physical network medium. In other embodiments, SCTP may be used as the transport protocol rather than TCP.

The host 152 may enable setup parameters for network connections. For example, the host 152 may setup transport layer parameters comprising information that support time stamping, window scaling, delayed acknowledgment policy, flow control scheme to be used, congestion handling, selective acknowledgement (SACK), buffers to be used, and/or other transport related parameters. The host 152 may also setup network layer parameters comprising information that supports IPv4 or IPv6, for example, and options such as no fragments and/or hop limit. The host 152 may also setup data link layer parameters comprising information that supports virtual local area networks (VLAN) and source address to be used, for example. In another embodiment of the invention, passive loop detection may be applicable to routers, gateways and other networking devices.

The CPU 156 may comprise suitable logic, circuitry, and/or code that may enable supporting of the management and/or performance of networking operations associated with remote peers or clients on a network. The CPU 156 may also enable supporting of the management and/or performance of service applications that may be provided to the remote clients on the network. The CPU 156 may also enable protection of sensitive resources.

The memory 158 may comprise suitable logic, circuitry, and/or code that may enable storage of information regarding the networking operations and/or service applications supported by the CPU 156. The chipset 160 may comprise suitable logic, circuitry, and/or code that may enable supporting of memory management, PCI master and arbitrator, graphics interface, I/O master for USB, audio, and/or peripheral devices, for example. In this regard, the chipset 160 may comprise at least one integrated circuit (IC) that provides services in support of the CPU 156 operations. In some instances, the services provided by the chipset 160 may be implemented in separate ICs. The choice of one or more ICs for implementing the chipset 160 may be based on the number and/or type of services provided.

The NIHW device 154 may comprise suitable logic, circuitry, and/or code that may enable communication with the host 152. In this regard, the NIHW device 104 may enable communication with the CPU 156, the memory 158, and/or the chipset 160. In some instances, the number of network connections that may be supported by the NIHW device 154 may be different than the number of network connections that may be supported by the host 152. For example, when the host 152 supports 10,000 connections and the NIHW device 154 supports 1,000 connections, then a connection ratio of 10:1 is supported by the networking system 150. In another example, if the host 152 supports 2,000 connections and the NIHW device 104 supports 1,000 connections, then a connection ratio of 2:1 is supported by the networking system 150. The connection ratio of a networking system that comprises a host and an NIHW device may be utilized when determining a connection setup model for a particular application.

FIG. 1C is a block diagram illustrating a host with a network interface hardware block integrated within a chipset, in accordance with an embodiment of the invention. Referring to FIG. 1C, there is shown a networking system 151 that may differ from the networking system 150 in FIG. 1B in that the NIHW device 154 in FIG. 1B is integrated into the chipset 160. In this regard, the NIHW device 154 may enable communication with other portions of the chipset 160, and with the CPU 156, and/or the memory 158 via the bus 162. The NIHW device 154 may comprise a classifier that may enable classification of received network packets.

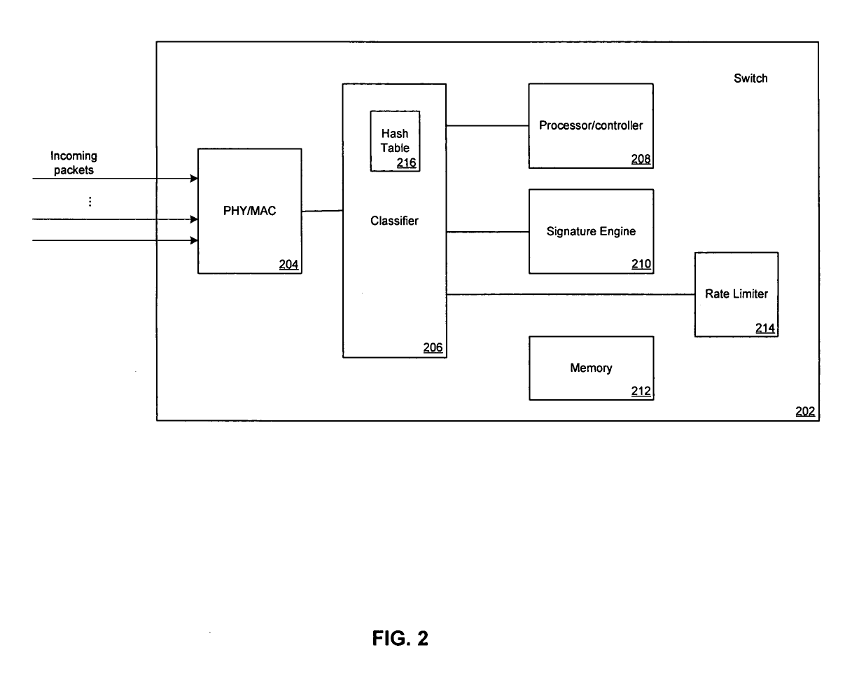

FIG. 2 is a diagram that illustrates a system for passive loop detection and prevention, in accordance with an embodiment of the invention. Referring to FIG. 2, there is shown a switch 202. The switch 202 comprises a physical (PHY)/(medium access control) MAC layer block 204, a packet classifier 206, a processor/controller 208, a signature engine 210, a rate limiter 214 and a memory 212. The packet classifier 206 may comprise a hash table 216.

The PHY/MAC layer block 204 may comprise suitable logic, circuitry and/or code that may enable managing and maintaining of communications between base stations by coordinating access to a shared channel, for example, a wired channel or a wireless channel and utilizing protocols that enhance communications over a network medium. The PHY/MAC layer block 204 may receive the incoming network packets and may output the received packets to the classifier 206.

The packet classifier 206 may comprise suitable logic, circuitry and/or code that may enable classification of received network packets. There is an increased likelihood of having collisions between the received network packets if, for example, a 4 byte cyclic redundancy check (CRC) is utilized, due to the limited number of bits being used. A 64 byte CRC may be utilized to reduce the likelihood of collisions between the network packets. To further decrease the likelihood of collisions, the CRC may be combined with other packet information to generate CRC-like hash information. A CRC is a type of hash function used to produce a checksum, which is a small, fixed number of bits against a block of data, such as a packet of network traffic. The checksum may be used to detect and correct errors after transmission or storage. A CRC may be computed and appended before transmission or storage, and verified afterwards by a recipient in order to confirm that no changes have occurred to the block of data during transmission.

The hash table 216 may be utilized to track a finite number of connection flows. For example, hashed entries for 5000 connection flows may be tracked and once the hash table is filled, a FIFO mechanism may be utilized to purge or eliminate older entries from the hash table in order to make space for newly hashed entries. The hash table 216 may be a data structure that associates keys with values. The hash table 216 may support lookup operations by transforming the key using a hash function into a hash, a number that the hash table 216 uses to locate the desired value.

The processor 208 may comprise suitable logic, circuitry, and/or code that may enable supporting of the management function to keep track of connections or traffic flows at the macro-level state. The macro-level state may indicate that only partial context information is maintained for each connection.

The signature engine 210 may comprise suitable logic, circuitry and/or code that may enable examining of the packets for each connection flow and generate various keys based on the hashed values of the CRC, for example. The rate limit engine 214 may comprise suitable logic, circuitry and/or code that may provide an enforcement function to limit a rate of various connections to a specified rate based on results from the packet classifier 206. It may be more efficient to throttle back a data rate that is associated with a connection than terminating a connection associated with a loop. For example, if a loop is detected for a particular connection, the rate limiter 214 may enable reduce a transmission rate of the connection from a million frames per second to 500 frames per second, for example.

The memory 212 may comprise suitable logic, circuitry and/or code that may enable storage of hash information used for generating the CRC or CRC-type hash information. There may be a tradeoff between accuracy and the amount of memory that is required to store hash information used for generating the CRC or CRC-type hash information. Notwithstanding, other methods may be utilized to generate the hash information, for example, using an XOR scheme.

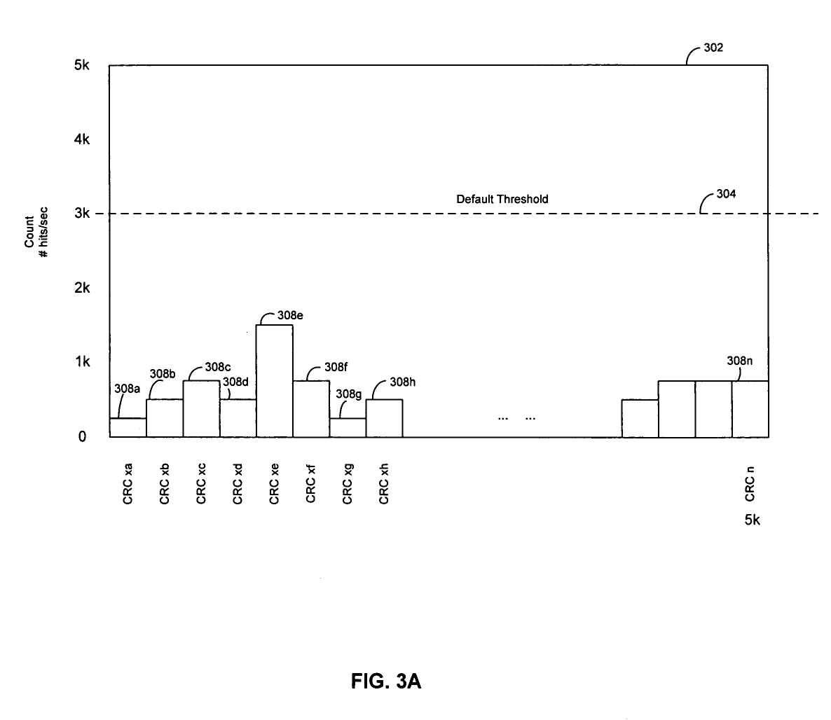

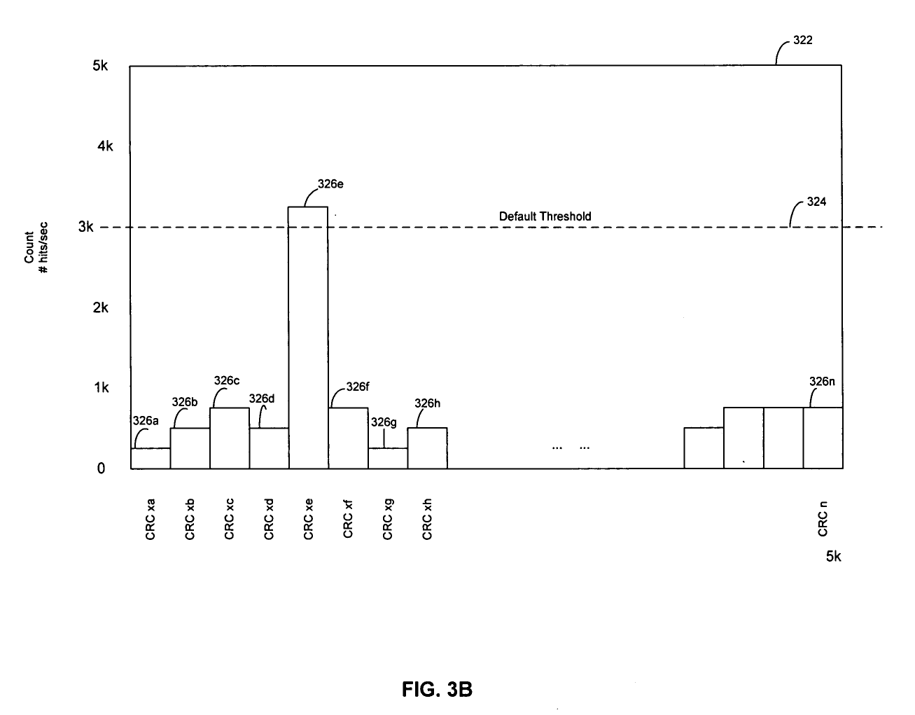

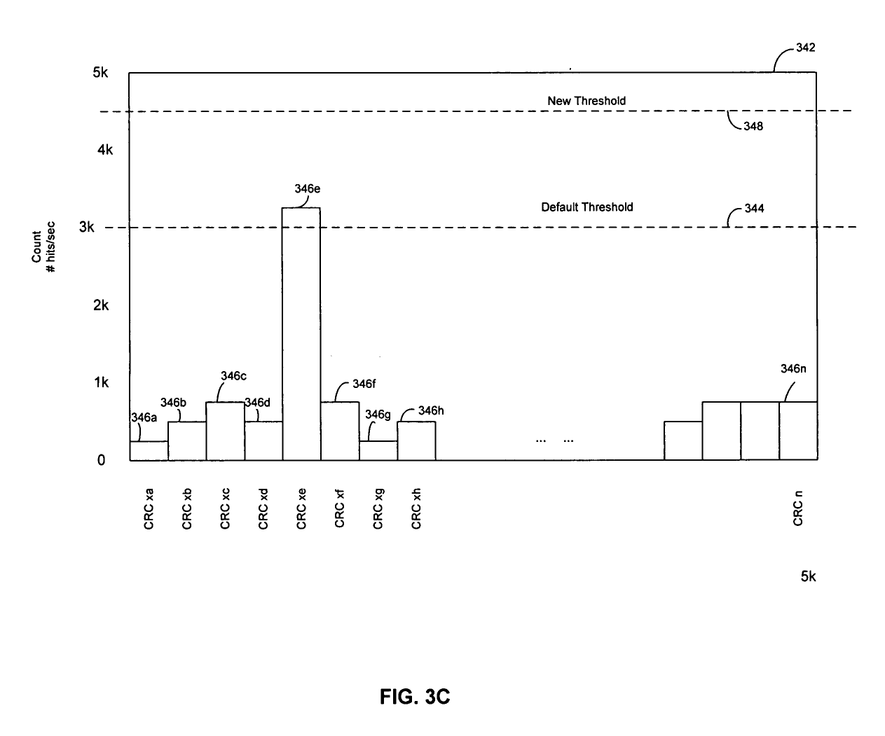

FIG. 3A is a diagram that illustrates an exemplary management function, in accordance with an embodiment of the invention. Referring to FIG. 3A, there is shown a graph 302 illustrating a relationship between hashed CRC values and their corresponding counts or number of occurrences. The horizontal axis illustrates the hashed CRC value, namely, CRC xa, CRC xb, CRC xc, CRC xd, CRC xe, CRC xf, CRC xg, CRC xh, . . . , CRC n. The vertical axis illustrates the count for each of the corresponding occurrences of the hashed CRC values CRC xa 308a, CRC xb 308b, CRC xc 308c, CRC xd 308d, CRC xe 308e, CRC xf 308f, CRC xg 308g, CRC xh 308h, . . . , CRC n 308n. Initially, the hash table may be populated with CRC hash entries until it is full. FIG. 3A illustrates a steady state condition in which there are 5000 entries in the hash table, for example. There is a default threshold 304 of 3000 packets per second, for example. Once the hash table is full, various mechanisms may be utilized to purge or otherwise remove entries from the hash table to make room for newly generated hash entries. For example, a FIFO mechanism may be utilized to remove hash entries. In this regard, the oldest entries in the hash table may be purged or otherwise removed first to make room for the newly generated CRC hash entries.

The first time a particular CRC hash is generated; it may be entered in the hash table with a count of 1. The second time that same CRC hash is generated; the count for that CRC hash entry may be incremented. Subsequent occurrences may result in the count for that CRC hash entry being incremented. In one embodiment of the invention, a threshold may be established for the CRC hash entries. If the rate of the packets exceeds an established threshold, then this may trigger an action such as a reduction in the data rate or terminating the connection.

FIG. 3B is a diagram that illustrates an exemplary scenario of a management function in which the default threshold has been exceeded, in accordance with an embodiment of the invention. Referring to FIG. 3B, there is shown a graph 322 illustrating a relationship between hashed CRC values and their corresponding counts or number of occurrences. The horizontal axis illustrates the hashed CRC value, namely, CRC xa, CRC xb, CRC xc, CRC xd, CRC xe, CRC xf, CRC xg, CRC xh, . . . , CRC n. The vertical axis illustrates the count for each of the corresponding occurrences of the hashed CRC values CRC xa 326a, CRC xb 326b, CRC xc 326c, CRC xd 326d, CRC xe 326e, CRC xf 326f, CRC xg 326g, CRC xh 326h, . . . , CRC n 326n.

FIG. 3B illustrates an exemplary scenario in which the number of occurrences of CRC xe 326e exceeds the default threshold 324. Once a threshold has been exceeded, then at least one of a plurality of actions may be triggered and executed by either the rate limiter 214 (FIG. 2) and/or the processor 208. These actions may comprise rate limiting, sending a management alarm, disabling one or more ports handling traffic in a loop, providing a visual or aural indication, and/or CPU redirect, for example.

A visual indication may comprise blinking a LED and an aural indication may comprise generating a beep. The blinking associated with a particular connection of the LED may follow a predefined sequence, for example. Rate limiting may involve blocking or dropping packets. With processor redirect, a copy of information in the hash table along with other connection context information may be copied or otherwise provided to the processor 208 for further analysis. Based on this analysis, the processor 208 may then determine how best to handle the condition and take appropriate actions. The processor 208 may provide an indication to the rate limiter 214, which may instruct the rate limiter 214 to adjust a rate of the corresponding connection accordingly. Context information such as a source port and a destination port, which may be associated with the hash entry for a particular packet, may be utilized to control a port. For example, the rate limiter 214 may use the source port or destination port to limit the data rate of the port or to disable the port.

FIG. 3C is a diagram that illustrates an exemplary scenario of a management function with an adaptive threshold, in accordance with an embodiment of the invention. Referring to FIG. 3C, there is shown a graph 342 illustrating a relationship between hashed CRC values and their corresponding counts or number of occurrences. The horizontal axis illustrates the hashed CRC value, namely, CRC xa, CRC xb, CRC xc, CRC xd, CRC xe, CRC xf, CRC xg, CRC xh, . . . , CRC n. The vertical axis illustrates the count for each of the corresponding occurrences of the hashed CRC values CRC xa 346a, CRC xb 346b, CRC xc 346c, CRC xd 346d, CRC xe 346e, CRC xf 346f, CRC xg 346g, CRC xh 346h, . . . , CRC n 346n. The number of occurrences of CRC xe 346e exceeds the default threshold 344. A new threshold 348 may be implemented at 4500 hits, for example, by the management function.

In this regard, the threshold may be dependent on the type of traffic handled by the connection. For example, if the traffic is largely multimedia traffic, and it is known that this type of environment is prone to loops, then the threshold may be increased to a higher level to more efficiently handle this type of traffic. For example, the threshold may be increased from 3000 to 4500, for example. At least one of a plurality of actions may be taken when a threshold has been reached. A default action may comprise executing a rate limiting action once a threshold has been exceeded. In certain instances, it may be appropriate to drop packets.

In another embodiment of the invention, the type of application running or the type of frame that is being detected may affect the action that may be taken by the processor 208 and/or the rate limiter 214. For example, if a frame is a unicast frame, the threshold may be changed and/or the count modified to favor acceptance of these types of frames. For example, in the case of a unicast frame, the count may be incremented by, for example, every 5 unicast frames for a particular CRC hash value. However, if the frame is a broadcast frame, then the threshold and/or count may be modified to disfavor the acceptance of these types of frames.

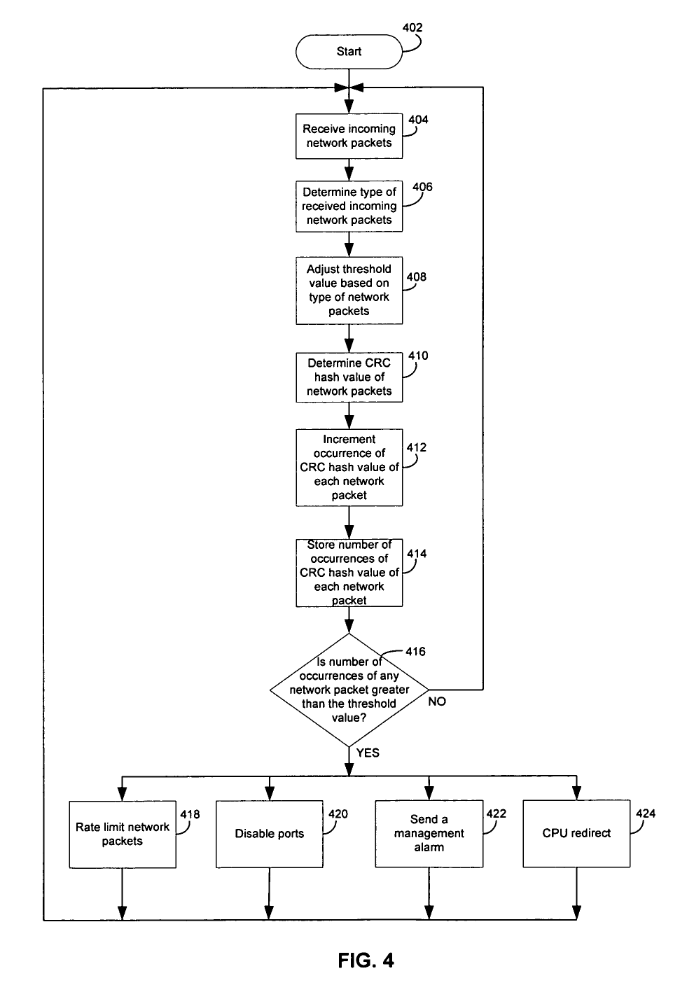

FIG. 4 is a flowchart illustrating a method for passive loop detection and prevention, in accordance with an embodiment of the invention. Referring to FIG. 4, exemplary steps may begin at step 402. In step 404, a plurality of network packets may be received at a port in a switching device. In step 406, the type of at least a portion of the plurality of received packets may be determined. In step 408, a threshold value of the number of occurrences of the CRC hash value may be set based on the determined type of the portion of the plurality of received packets. For example, if the traffic is largely multimedia traffic, and it is known that this type of environment is prone to loops, then the threshold may be increased to a higher level to more efficiently handle this type of traffic. In step 410, a CRC hash value of each of the plurality of received network packets may be determined. In step 412, a counter may be incremented to indicate the number of occurrences of the CRC hash value of each of the plurality of received network packets. In step 414, the memory 212 may enable storage of the number of occurrences of the CRC hash value of each of the plurality of received network packets.

In step 416, it may be determined whether the number of occurrences of the CRC hash value of any of the plurality of received network packets is greater than the set threshold value. If the number of occurrences of the CRC hash value of at least one of the plurality of received network packets is not above the set threshold value, control returns to step 404. If the number of occurrences of the CRC hash value of at least one of the plurality of received network packets is above the set threshold value, control passes to at least one of steps 418, 420, 422, or 424.

In step 418, the rate of at least a portion of the plurality of received network packets at a port in a switching device may be adjusted, for example, by the rate limiter 214 (FIG. 2). Rate limiting may involve blocking or dropping packets, for example. In step 420, at least one of a plurality of ports handling at least one of the plurality of received network packets may be disabled. In step 422, a visual indication, for example, a blinking LED or an aural indication comprising generating a beep may be transmitted to the processor 208. In step 424, a copy of information in the hash table along with other connection context information may be copied or otherwise provided to the processor 208 for further analysis. Based on this analysis, the processor 208 may then determine how best to handle the condition and take appropriate actions. The processor 208 may provide an indication to the rate limiter 214, which may instructs the rate limiter 214 to adjust a rate of the corresponding connection accordingly. Control then returns to step 404.

In accordance with an embodiment of the invention, a method and system for passive loop detection and prevention in a packet network switch may comprise detecting a loop 110 within a switching device 102 in a communication network 108 based on a number of occurrences of at least a portion of a plurality of received network packets at a port, for example, port 1 106 or port 2 104 in a switching device 102. The rate at which at least a portion of the plurality of received network packets are handled may be adjusted at the port, for example, port 1 106 or port 2 104 in the switching device 102. At least one of the plurality of received network packets may be rate limited, for example, by the rate limiter 214 (FIG. 2), if the number of occurrences of a CRC hash value of at least one of the plurality of received network packets is above a first threshold value 324 (FIG. 3B). The system may comprise circuitry that enables determination of a cyclic redundancy check (CRC) hash value of each of the plurality of received network packets. The memory 212 may enable storage of a number of occurrences of the CRC hash value of each of the plurality of received network packets.

The classifier 206 may determine whether the number of occurrences of the CRC hash value of at least one of the plurality of received network packets is above a first threshold value 324. At least one of a plurality of ports handling at least one of the plurality of received network packets may be disabled, if the number of occurrences of the CRC hash value of at least one of the plurality of received network packets is above the first threshold value 324. The processor 208 may enable adjustment of a threshold value of the number of occurrences of the CRC hash value of the plurality of received network packets based on a type of at least a portion of the plurality of received network packets. For example, if the processor 208 determines that the traffic is largely multimedia traffic, and it is known that this type of environment is prone to loops, then the threshold may be increased to a higher level to more efficiently handle this type of traffic.

Another embodiment of the invention may provide a machine-readable storage, having stored thereon, a computer program having at least one code section executable by a machine, thereby causing the machine to perform the steps as described above for passive loop detection and prevention in a packet network switch.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for handling data in a communication network, the method comprising:
detecting a loop within a switching device based on a number of occurrences of at least a portion of a plurality of received network packets at a port in said switching device; and
adjusting a rate at which said at least portion of said plurality of received network packets are handled at said port in said switching device.

2. The method according to claim 1, wherein said port in said switching device is at least one of: an input port and an output port.

3. The method according to claim 1, further comprising determining a cyclic redundancy check (CRC) hash value of each of said plurality of received network packets.

4. The method according to claim 3, further comprising storing a number of occurrences of said CRC hash value of each of said plurality of received network packets.

5. The method according to claim 4, further comprising determining if said number of occurrences of said CRC hash value of at least one of said plurality of received network packets is above a first threshold value.

6. The method according to claim 5, further comprising if said number of occurrences of said CRC hash value of said at least one of said plurality of received network packets is above said first threshold value, adjusting said rate at which said at least one of said plurality of received network packets are handled.

7. The method according to claim 5, further comprising if said number of occurrences of said CRC hash value of said at least one of said plurality of received network packets is above said first threshold value, disabling at least one of a plurality of ports in said switching device handling said at least one of said plurality of received network packets.

8. The method according to claim 5, further comprising adjusting a threshold value of said number of occurrences of said CRC hash value of said plurality of received network packets based on a type of at least a portion of said plurality of received network packets.

9. A machine-readable storage having stored thereon, a computer program having at least one code section for handling data in a communication network, the at least one code section being executable by a machine for causing the machine to perform steps comprising:
detecting a loop within a switching device based on a number of occurrences of at least a portion of a plurality of received network packets at a port in said switching device; and
adjusting a rate at which said at least portion of said plurality of received network packets are handled at said port in said switching device.

10. The machine-readable storage according to claim 9, wherein said port in said switching device is at least one of: an input port and an output port.

11. The machine-readable storage according to claim 9, further comprising code for determining a cyclic redundancy check (CRC) hash value of each of said plurality of received network packets.

12. The machine-readable storage according to claim 11, further comprising code for storing a number of occurrences of said CRC hash value of each of said plurality of received network packets.

13. The machine-readable storage according to claim 12, further comprising code for determining if said number of occurrences of said CRC hash value of at least one of said plurality of received network packets is above a first threshold value.

14. The machine-readable storage according to claim 13, further comprising code for adjusting said rate at which said at least one of said plurality of received network packets are handled, if said number of occurrences of said CRC hash value of said at least one of said plurality of received network packets is above said first threshold value.

15. The machine-readable storage according to claim 13, further comprising code for disabling at least one of a plurality of ports in said switching device handling said at least one of said plurality of received network packets, if said number of occurrences of said CRC hash value of said at least one of said plurality of received network packets is above said first threshold value.

16. The machine-readable storage according to claim 13, further comprising code for adjusting a threshold value of said number of occurrences of said CRC hash value of said plurality of received network packets based on a type of at least a portion of said plurality of received network packets.

17. A system for handling data in a communication network, the system comprising:
circuitry that enables detecting a loop within a switching device based on a number of occurrences of at least a portion of a plurality of received network packets at a port in said switching device; and
circuitry that enables adjusting a rate at which said at least portion of said plurality of received network packets are handled at said port in said switching device.

18. The system according to claim 17, wherein said port in said switching device is at least one of: an input port and an output port.

19. The system according to claim 17, further comprising circuitry that determines a cyclic redundancy check (CRC) hash value of each of said plurality of received network packets.

20. The system according to claim 19, further comprising circuitry that enables storage of a number of occurrences of said CRC hash value of each of said plurality of received network packets.

21. The system according to claim 20, further comprising circuitry that determines whether said number of occurrences of said CRC hash value of at least one of said plurality of received network packets is above a first threshold value.

22. The system according to claim 21, further comprising circuitry that enables adjusting said rate at which said at least one of said plurality of received network packets are handled, if said number of occurrences of said CRC hash value of said at least one of said plurality of received network packets is above said first threshold value.

23. The system according to claim 21, further comprising circuitry that disables at least one of a plurality of ports in said switching device handling said at least one of said plurality of received network packets, if said number of occurrences of said CRC hash value of said at least one of said plurality of received network packets is above said first threshold value.

24. The system according to claim 21, further comprising circuitry that enables adjustment of a threshold value of said number of occurrences of said CRC hash value of said plurality of received network packets based on a type of at least a portion of said plurality of received network packets.
